(19) United States
(12) Patent Application Publication
(10) Pub. No.: US 2015/0026707 A1
(43) Pub. Date: Jan. 22, 2015

(54) AUDIENCE RESPONSE DETERMINATION TO DIGITAL-MEDIA CONTENT

(71) Applicant: iHeartMedia Management Services, Inc., San Antonio, TX (US)

(72) Inventors: Mikhail Lisovich, New York, NY (US); Christopher Keune, Brooklyn, NY (US); Philippe Generali, Scarsdale, NY (US); Joaquin Torsiello, Yonkers, NY (US); John Fulbright, Ogallala, NE (US); David C. Jellison, JR., Ogallala, NE (US)

(73) Assignee: iHeartMedia Management Services, Inc., San Antonio, TX (US)

(21) Appl. No.: 14/509,861

(22) Filed: Oct. 8, 2014

Related U.S. Application Data
(63) Continuation-in-part of application No. 12/539,885, filed on Aug. 12, 2009.
(60) Provisional application No. 61/136,092, filed on Aug. 12, 2008.
(60) Provisional application No. 61/193,515, filed on Dec. 4, 2008.

(51) Int. Cl. H04N 21/442; H04H 60/33

(52) U.S. Cl. CPC H04N 21/44222; H04H 60/33
USPC 725/11; 725/14

(57) ABSTRACT

An apparatus and method for execution in a digital-media content playback device is provided, in which a digital-media content stream is received that includes a plurality of digital-media content provided by at least one digital-media content service. For a playback of each of the plurality of digital-media content via the digital-media content playback device, a playback duration is determined, and a churn rate based on the playback duration relative to the airplay parameter of the corresponding digital-media content to indicate a digital-media content switch by a user. The churn rate of a digital media content-of-interest is produced based on churn rates of a plurality of digital-media content to produce a retention rate relating the digital media content-of-interest. Digital-media content information is transmitted by the digital-media content playback device including the playback duration, the churn rate, and the retention rate relating to the digital media content-of-interest.

### RELATED APPLICATIONS

The present U.S. Utility patent application claims priority pursuant to 35 U.S.C. §120 as a continuation-in-part of U.S. Utility application Ser. No. 12/539,885, entitled “Determining Audience Response to Broadcast Content,” filed Aug. 12, 2009, which claims priority pursuant to 35 U.S.C. §119(e) to U.S. Provisional Application No. 61/193,515, entitled “Measuring Audience Reaction,” filed Dec. 4, 2008, and U.S. Provisional Application No. 61/136,092 entitled “Determining Audience Response to Broadcast Content,” filed Aug. 12, 2008, all of which are hereby incorporated herein by reference in their entirety and made part of the present U.S. Utility patent application for all purposes.

### FIELD

The present disclosure relates generally to analyzing data related to media audiences, and more particularly to evaluating audience responses to particular media content.

### BACKGROUND

Audience demographics and consumption habits are frequently used in selling advertising for broadcast content providers and media stations in industries such as terrestrial and satellite radio, cable, Internet, cellular telephone and other wireless communications, newspapers, billboards, and the like. Media stations are often rated or ranked based on audience membership, listener-ship, viewer-ship, webpage hits, and the like. A greater number of audience members generally results in a higher rating, and potentially greater advertising revenue. This type of information is available from a variety of conventional sources. Nielsen Audio, for example, collects audience exposure data and provides it in various formats, including “Portable People Meter” (PPM) data.

Information about which media programs are broadcast on particular stations at particular times is also used by content providers for various purposes. For example, data related to broadcast content can help evaluate a station's compliance with advertising programs and broadcast schedules. Data identifying stations on which a particular media program was broadcast, and corresponding broadcast times, is available from sources such as Media Monitors, which collects audio from various media stations using field sites in major markets.

Various statistical techniques are commonly used to evaluate available data. However, currently employed evaluation techniques do not take into account all of the possible ways of data from various different sources can be usefully combined and evaluated.

### SUMMARY

Audience response to broadcast content can be gauged by determining how many audience members switched stations while particular programs were broadcast. A method according to at least one embodiment includes receiving audience data indicating how many audience members were tuned to a station at different times, and receiving content data indicating broadcast times during which each of a plurality of content items was broadcast on the station. The number of a number of audience members who tuned away from a station during a first broadcast of a first content item, referred to as “content-switches,” can be determined. A determination of how many audience members were expected to tune away from the station during the first broadcast of the first content item can also be made. A performance factor can then be assigned to the first content item based on a relationship between how many audience members tuned away and how many audience members were expected to tune away.

In various embodiments, an average number of audience members who tuned away from the station during each respective minute of the day, referred to as a “station-average,” can be determined for each minute of a day. The average number of audience members of the station for each minute of the day can also be determined, and a station switch average can be determined for a first group of times. The first group of times includes a period of time during the first broadcast of the first content item. The station-switch average corresponds to an average of the station averages.

A “switch percent” can also be determined for the first group of times. The switch percent includes subtracting the station switch average from the number of content switches, and dividing the result by the average number of audience members. In some embodiments, additional switch percentages are determined for multiple second groups of times. Each of the second groups of times corresponds to additional broadcasts of the first content item. A periodic switch percentage can also be determined based on an average of the additional switch percentages. Multiple periodic switch percentages can be determined, as can a rolling average of the periodic switch percentages over a designated interval.

In some embodiments, the number of audience members who tuned away from the station is a net-number of audience members who tuned away, based on a difference between a raw number of audience members who tuned into the station during a first broadcast of a first content item and a raw number of audience members who tuned away from the station during a first broadcast of a first content item.

Some methods receive audience data indicating how many audience members were tuned to each of a plurality of media stations at different times, and content data indicating times during which each of a plurality of programs was aired on each of the plurality of media stations. Based on the audience data and the content data, the number of audience members who tuned-in to each of the plurality of media stations during times particular programs were aired, and the number of audience members who tuned-away from each of the plurality of media stations during times the particular programs were aired, can be determined.

Various methods retrieve a plurality of event records that match specified criteria, wherein each of the plurality of event records represents an audience member that was tuned to one of the plurality of media stations during a time one of the plurality of programs was aired. A number of audience members who tuned away from a station can be determined based on the presence of a retrieved event record for a first period of time, and the lack of a retrieved event record for a second period of time. Conversely, a number of audience members who tuned in to a station can be determined based on the lack of a retrieved event record for a first period of time, and the presence of an event record for a second period of time.

Overlapping event records can be eliminated prior to determining a number of switching events, e.g. tune-in or tune-away events, for a program.

Various embodiments may take the form of a system including a processor, memory, a communications interface adapted to receive audience and content data, and a program of instructions including instructions to implement any of the various methods described herein.

### BRIEF DESCRIPTION OF THE DRAWINGS

Aspects of this disclosure will become apparent upon reading the following detailed description and upon reference to the accompanying drawings, in which like references may indicate similar elements:

FIGS. 1 and 2 are graphs showing relationships between a number of audience members who switch, migrate, or tune-away from one or more stations and a number of audience members expected to do so, according to embodiments of the present disclosure;

FIG. 3 is a flow chart illustrating a method according to various embodiments of the present disclosure;

FIG. 4 is a flow chart illustrating another method according to various embodiments of the present disclosure;

FIG. 5 is a high level block diagram of a processing system according to embodiments of the present disclosure;

FIG. 6 is a high level block diagram of a system according to embodiments of the present disclosure;

FIG. 7 illustrates an example of data collection of playback of digital media content via a digital media content playback device for transmission to processing system according to embodiments of the present disclosure;

FIG. 8 illustrates another embodiment where a switch involves a tune-out or transition to other channels of the digital media content;

FIG. 9 illustrates determining a retention rate based on factored churn rate for a digital media content-of-interest;

FIG. 10 is a flow chart illustrating a method according to various embodiments of the present disclosure; and

FIG. 11. is another flow chart illustrating another method according to various embodiments of the present disclosure

### DETAILED DESCRIPTION

Various embodiments described herein can be used for determining audience response to broadcast content by evaluating audience switching by, e.g., time, content-provider, market, content type, socio-demographics and in general any grouping or subdivision of those, as well as any other kind of audience measurement such as web site impressions.

In certain embodiments the data used for the evaluation includes radio data, TV data, internet data, billboard data, print-media data, cellular data, WiFi data, WiMAX data, and other data associated with distribution of events, content, etc. delivered via a variety of distribution technologies, including without limitation analog, FM, HD, and digital data technologies, print media, billboards, etc. Other embodiments, in addition to those specifically described herein, can be implemented using the teachings described herein.

An audience's exposure to content is important to understanding and providing information to content providers, for example as broadcasters, media companies and advertisers, who may use the audience exposure information along with content verification data to more accurately determine audience response, and set associated fees that the industry can confidently use to determine cost and revenue, as well as placement. Determining audience retention for content can be invaluable to providing a stable audience for rating content consumption, and for selling advertising, as well as providing information on media play.

Various embodiments described herein allow a determination of what audience members, or consumers, are doing on a minute-by-minute basis. Using this technology, radio programmers, for example, have a new level of capability provided by more accurately knowing the actual listeners' behavior. Users of various embodiments have access to airplay data combined with consumer exposure minute by minute data.

A person skilled in the art and knowledgeable of database design and of data retrieval knows the ratings information available to a ratings service. For example audience data provider services such as the Nielsen Audio ratings service, and content data provider services such as Media Monitors ratings service are available to provide data for analysis according to the present disclosure. Various analysis techniques described herein can also utilize other, suitable types of data obtained from various logs event lists or other data sources. This ratings data can be known at least at the level of every increment of time period, which can be a second, minute, hour, daypart, day, week, month, or the like, and provides information about what audience members are doing as it relates to the content that is being presented to the audience at that time. This ratings information can be numerically analyzed, charted, and trended for relationships to audience preferences, which in some instances are indicated by audience members tuning or switching away from a content provider.

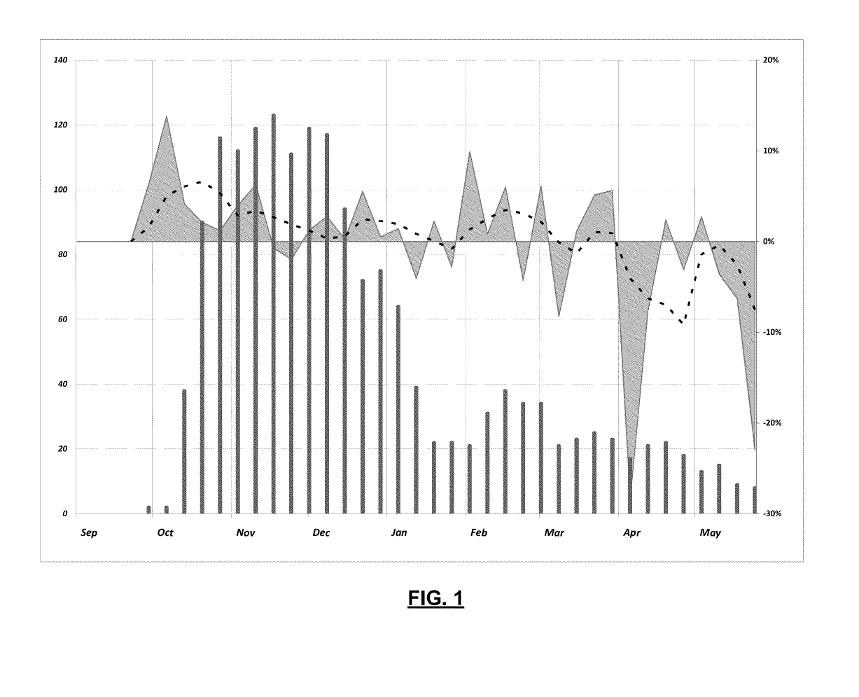

Referring to FIGS. 1 and 2, graphs illustrating how data can be analyzed and charted according to one or more embodiments of the present disclosure are illustrated. The numbers along the left Y₁ axis on the left side of graphs represent the number of times particular content, was aired during a given period of time. The time periods run along the X axis of the graphs. The numbers along the Y₂ axis on the right side of the graphs represent a percent value of audience members tuning away, or switching to a different station, with 0% representing an expected, or normalized, percentage of switches.

TABLE 1

| | Airplay | Switching |
|---|---|---|
| Oct. 1, 2007 | 2 | 6.4% |
| Oct. 8, 2007 | 2 | 13.8% |
| Oct. 15, 2007 | 38 | 4.1% |
| Oct. 22, 2007 | 90 | 2.1% |
| Oct. 29, 2007 | 116 | 1.2% |
| Nov. 5, 2007 | 112 | 4.0% |
| Nov. 12, 2007 | 119 | 6.3% |
| Nov. 19, 2007 | 123 | −0.7% |
| Nov. 26, 2007 | 111 | −2.0% |
| Dec. 3, 2007 | 119 | 1.3% |
| Dec. 10, 2007 | 117 | 2.8% |
| Dec. 17, 2007 | 94 | 0.3% |
| Dec. 24, 2007 | 72 | 5.5% |
| Dec. 31, 2007 | 75 | 0.5% |
| Jan. 7, 2008 | 64 | 1.4% |
| Jan. 14, 2008 | 39 | −4.1% |
| Jan. 21, 2008 | 22 | 2.3% |
| Jan. 28, 2008 | 22 | −2.8% |
| Feb. 4, 2008 | 21 | 9.9% |
| Feb. 11, 2008 | 31 | 0.8% |
| Feb. 18, 2008 | 38 | 6.0% |
| Feb. 25, 2008 | 34 | −4.3% |
| Mar. 3, 2008 | 34 | 6.1% |
| Mar. 10, 2008 | 21 | −8.3% |
| Mar. 17, 2008 | 23 | 1.2% |
| Mar. 24, 2008 | 25 | 5.2% |
| Mar. 31, 2008 | 23 | 5.6% |
| Apr. 7, 2008 | 17 | −28.3% |
| Apr. 14, 2008 | 21 | −7.6% |
| Apr. 21, 2008 | 22 | 2.4% |
| Apr. 28, 2008 | 18 | −3.1% |
| May 5, 2008 | 13 | 2.7% |
| May 12, 2008 | 15 | −3.6% |
| May 19, 2008 | 9 | −6.3% |
| May 26, 2008 | 8 | −23.0% |

TABLE 2

| | Airplay | Switching |
|---|---|---|
| Sep. 3, 2007 | 4 | −26.0% |
| Sep. 10, 2007 | 1 | 22.3% |
| Sep. 17, 2007 | 1 | 6.2% |
| Sep. 24, 2007 | 37 | 13.7% |
| Oct. 1, 2007 | 52 | 9.9% |
| Oct. 8, 2007 | 53 | 11.6% |
| Oct. 15, 2007 | 47 | 8.1% |
| Oct. 22, 2007 | 89 | 5.4% |
| Oct. 29, 2007 | 107 | 6.1% |
| Nov. 5, 2007 | 109 | 3.9% |
| Nov. 12, 2007 | 114 | 5.6% |
| Nov. 19, 2007 | 116 | 3.0% |
| Nov. 26, 2007 | 109 | 1.7% |
| Dec. 3, 2007 | 108 | 2.4% |
| Dec. 10, 2007 | 105 | 0.9% |
| Dec. 17, 2007 | 111 | 1.3% |
| Dec. 24, 2007 | 110 | 4.0% |
| Dec. 31, 2007 | 80 | 6.4% |
| Jan. 7, 2008 | 79 | 2.3% |
| Jan. 14, 2008 | 92 | 7.9% |
| Jan. 21, 2008 | 46 | −1.9% |
| Jan. 28, 2008 | 24 | 1.2% |
| Feb. 4, 2008 | 18 | 4.4% |
| Feb. 11, 2008 | 19 | 7.2% |
| Feb. 18, 2008 | 19 | 7.8% |
| Feb. 25, 2008 | 17 | 6.2% |
| Mar. 3, 2008 | 9 | 12.9% |
| Mar. 10, 2008 | 8 | −2.6% |
| Mar. 17, 2008 | 1 | 2.4% |
| Mar. 24, 2008 | 2 | 10.9% |
| Mar. 31, 2008 | 2 | 14.3% |
| Apr. 7, 2008 | 3 | 3.3% |
| Apr. 14, 2008 | 3 | 2.2% |
| Apr. 21, 2008 | 3 | 9.7% |
| Apr. 28, 2008 | 4 | 15.4% |
| May 5, 2008 | 5 | 2.4% |
| May 12, 2008 | 4 | 5.8% |
| May 19, 2008 | 4 | −9.0% |
| May 26, 2008 | 4 | 0.1% |

The data from Tables 1 and 2 are plotted in FIGS. 1 and 2, respectively, and illustrate the following.
1. Upper-half or positive area—less audience tune-out (more retained audience)
2. Lower-half or negative area—more audience tune-out (less retained audience)
3. Histogram—play count for the week
4. Dotted line—multi-week (e.g., 4 week) moving average
5. Flat line at 0%—average tune-out (normalized tune-out)

For example, assume a time period of 12:00 noon to 12:05 PM on a given day, and content-provider/market. During that period, various embodiments can perform the following:
a. determine the average number of audience participants (media consumers—e.g., listeners, viewers) switching in or out and tuning in or out at that time, during the presentation of the content being provided to the audience; and
b. look at this same time period of the day over a range of days and times during the week, across all months, and determine a value of switching or net audience over/under an average tune-out value for that period.

Using a log of content that has been presented to consumers, this same analysis may be performed for other plays of the same content over a period of time, which may be or may not be independent of the range of time mentioned in b.

The trend information can be based, for example, on specified content play at a given station, market or other level as desired. Additionally, in various embodiments the data could also be used to represent advertising, promotions, and other content.

Various embodiments of the disclosure allow a content provider to determine the efficacy of their content relative to a target audience, and in some embodiments assign a ranking, rate or other performance factor to a particular item of content. Reporting this information, including in some cases the performance factor, to key users such as media companies, ad agencies, advertisers, promotion sponsors, and the like, can allow these key users to adjust their content to attract and/or retain more audience and therefore more advertising revenue.

Various embodiments described herein are directed to methods and systems for analyzing and trending audience tune-out by time, station, and market. Some embodiments integrate different data formats of an audience data provider service (e.g., Arbitron, Nielsen Audio, etc.) and a content data provider service (e.g., Media Monitors) to provide a unique analysis of the information that makes it more usable to broadcast and advertising personnel. That is, audience data is received from an audience data provider, for example Arbitron and/or Nielsen Audio, which provides the data related to what media a target audience is consuming at a given time. A content data provider service, for example, Media Monitors, can provide the instance of content information as to what media is played, and when and how frequently that particular media is played. In other embodiments, either or both of the audience and content data can be received from other sources or be generated as part of an implementation of the present disclosure.

As noted above, Tables 1 and 2 include examples of airplay data and switching percentages as might be determined according to embodiments of the present disclosure using audience data provider services and content data provider services.

Various embodiments of the present disclosure provide a way to integrate the instance of media content information and media consumer data to provide an analysis of consumer switching to a more detailed level. In some embodiments involving radio or streaming audio, for each airplay, and the corresponding day and song play duration for that airplay within the data range, the average number of station switches is calculated. This method could easily be provided for other media content such as video, text, written content, television, internet, etc., other media content providers such as television stations and websites, and other consumers such as television viewers, internet users, or the like.

In at least one radio or streaming internet audio embodiment, for example, “Never too late” is played by Three Days Grace from Big Shiny Tunes Vol. 12 on Monday at 1:30 to 1:35 PM. For every Monday and each song play duration of 5 minutes at 1:30 to 1:35—for any song airplay at that day and time, method 300 can determine the Number of Switches that occurred, across the entire data range. Method 300 can calculate the average station switches as: Number of Switches divided by No. of days in data range=Station Average Switches for that day and time slot for any song on that station. Method 300 can also calculate the average station listeners as: Number of Listeners divided by No. of days in data range=Station Average Listeners for that day and time slot for any song on that station.

For example, using the data range provided in Table 1, there are 35 data points from Oct. 1, 2007 through May 26, 2008. For week 35, May 26, 2008, there are 8 airplays, so the method repeats the above steps for all 8 airplays of Three Days Grace from Big Shiny Tunes Vol. 12.

For each airplay in the period, the method performs the following:
a) Find the average song switches for the airplay by summing all of the switches for each minute of airplay of that song and divide by the duration of the song in minutes.
b) Find the average of the station average switches for the corresponding day and time slot by summing all of the station average switches for the day and time slot and dividing by the duration of the song in minutes.
c) Find the difference of the above two averages; by subtracting the average of the station average switches from the average song switches.
d) Find the percent difference (airplay switch percent) by dividing the result from the prior step by the average of the station average listeners for the week. That is, [(average of the song switches)−(average station average switches)]/(average of the station average listeners)*100*−1.

Based on these calculations, the resultant number (the switch percent assigned to an occurrence of content) is normalized against the expectation for that content provider at the time the content aired. If the average of the song switches is less than the average station average switches, then the resultant number is positive, meaning that more audience members were retained than expected. If the average of the song switches is equal to the average of the station average switches, then the resultant number is 0, meaning that retention is exactly what was expected. If the average of the song switches is greater than the average of the station average switches, then the resultant number is negative, which means that the audience retention is less than expected.

For all airplays of the same content from the same provider in the week (period), the method finds the average percent difference (switch percent) by summing all of the percent differences found in step (d) above and dividing by the number of times the content aired. That is, (sum(switch percent))/(number of content airplays in the period).

If the resultant number is negative, then this indicates more switches occurred that week on average, and there was less retained audience. If the resultant number is positive, then it indicates fewer switches occurred that week on average, and there was more retained audience for the airplay overall that week.

Switch percentages are calculated at the given specified content instance level (Airplay Switch Percent) and at the content level (Switch Percent). The instance level refers to each given specified instance of the content within the period of time being analyzed. The content level refers to the aggregate of all instances of a given piece of content within period.

Airplay Switch Percent=

((PL.Consumers_Switched_Out)−(PL.Consumers_Switched_Out_Avg))/(PL.LC_Total_Content_Provider_Avg)*100.00)*−1

WHERE
a. PL.Consumers_Switched_Out=The number of consumers who switched to another content provider during a given specified content instance in the period;
b. PL.Consumers_Switched_Out_Avg=The average of the average number of consumers who switch to another content provider during the minutes of the day at which the given specified content instance played.
c. PL.LC_Total_Content_Provider_Avg)=The average of average number of consumers who are tuned in to the content provider during the minutes of the day at which the given specified content instance played.
d. In some embodiments, the number of days used to derive the average number of consumers tuned in to a content provider or the average number of consumers who switch to another content provider is 91 days (13 weeks).

Switch Percent=

sum(Airplay_Switch_Percent)/(Instance_Count)

WHERE
a. Airplay_Switch_Percent=The Airplay Switch Percentage calculated for a given specified content instance played
b. Instance_Count=The number of specified content instances in the period.

Put another way, Airplay Switch Percent=((Reaction to the specified content each time it is an instance of content)−(normal reaction on this content provider at those times))/(normal audience on this content provider at those times). Switch Percent=the average Airplay Switch Percent for a given piece of content over a given period of time.

In some embodiments, a 4-week moving average is calculated as the sum of the prior 3 weeks and the current week then divided by 4.

The content provider's consumers who switch away while this specified content is being played is compared to the content provider's consumers who switch away at those same times of the day regardless of what is being played, and is expressed as a percentage of the content providers average audience at those times of day. This yields a “Normalized” percentage of consumers switched out during the play of the specified content being analyzed, in each period.

Switch Percent is the value plotted on the graphs shown in FIGS. 1 and 2. A positive number on the graphs of FIGS. 1 and 2, therefore, indicates a positive audience reaction; a negative number is a negative reaction.

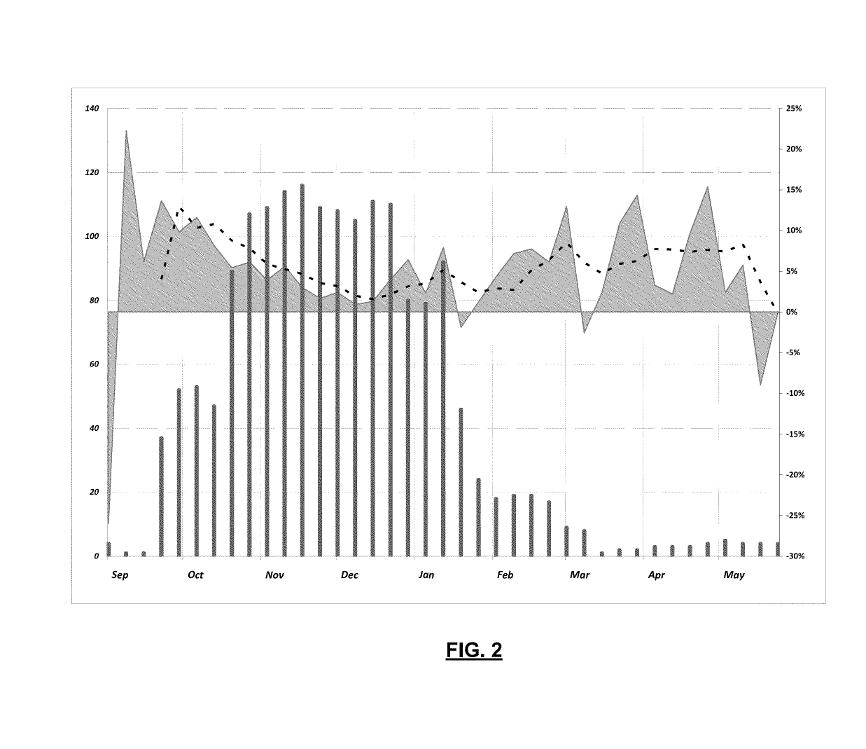

Referring now to FIG. 3, a method 300 is discussed according to various embodiments of the present disclosure. As illustrated by block 303, content data can be received from a content monitoring data provider. Particular instances of content data detail can be identified, as illustrated by block 305. These particular instances of content data detail can include, but are not limited to, information such as a station on which the content aired, a date of broadcast, the minutes of the day during which the instance of content aired, and the like.

As illustrated by block 307, particular content to be evaluated can be selected. For example a particular song, movie, program, advertisement, or other content can be selected for evaluation based on information contained in the content data detail or otherwise. As illustrated by block 309, the number of instances that particular content was broadcast over a desired evaluation period can be determined. In some embodiments, that time period can be a week, but other periods of evaluation can be selected as desired.

As illustrated by block 313, for each time the selected content aired on a particular station, the day of the week and time slot can be determined. It should be noted that in some embodiments, basing the evaluation on the day of the week is optional. In some instances, content that airs during selected hours, for instance between midnight and 4 am, may also be excluded from the calculations to reduce potential data skewing effects.

As illustrated by block 315, for each instance of content, day and time being considered, a number of corresponding switches can be determined. The number of corresponding switches may include only instances in which audience members tuned away from the station, or a net number of switches can be determined based on a number of both tune-in events and tune-away events.

Determining the number of switches that occur during the broadcast of particular content involves, in at least some embodiments, merging content data with audience data. As illustrated by block 329, audience data can be received from an audience data provider or other source. As illustrated by block 333, detailed audience data can be selected by period, but may in some instances be selected based on other criteria.

As illustrated by block 335, a consumer identifier associated with each record of audience data is determined in at least one embodiment. As further illustrated by block 337, for each consumer identifier, session data can be determined. Session data includes, but is not limited to, station identifiers, and start and end values, as illustrated by block 339. Thus the session data can be used to identify which station a particular audience member was tuned to at any particular time.

As illustrated by block 343, a determination can be made regarding whether a content provider end value meets or overlaps a subsequent start value for a particular instance of content. As shown by block 345, a switch occurs if an end value meets or overlaps with a subsequent start value, then a switch has occurred.

The presence or absence of a switch, as determined at block 345, can be used in conjunction with content data at block 315 to determine how many switches occurred during a particular instance of content. As illustrated at block 317, the average number of switches for a particular content provider at corresponding day and time slot can be calculated over the data range. In some embodiments, this average can be an expected number of switches. Thus, it can be determined that a particular station experiences an average number of switches every Monday at 4:01 pm, for example. It should be noted that in some embodiments, the day of the week is not factored into the determination of the average number of switches. So, for example, an average number of switches at 4:01 pm based on every day of the week can be determined. In further embodiments, weekends or weekdays can be treated separately or together, depending on a desired calculation.

As illustrated at block 319, an average number of switches for all instances of content aired during an evaluation period can be calculated. In the illustrated embodiment the evaluation period is a week, but other periods of time, for example a month, three weeks, or a year can be used.

As illustrated by block 323, a percentage of switches can be calculated, and charted. Furthermore, as illustrated by blocks 325 and 327, in some embodiments, a performance factor can be assigned based on a relationship between an expected number of switches and an actual number of switches. Block 325 illustrates that if the percentage of switches is greater than an average, or expected number of switches, less audience is retained. Block 327 illustrates that if the percentage of switches is less than the average, or expected number of switches, more audience is retained. A performance factor, in at least some embodiments, indicates whether more or less audience is retained. In some embodiments, a performance factor may include a degree to which more or less audience is retained.

Although much of the above discussion relates to analyzing and aggregating audience data from one or more media outlets for an instance of content on a particular station, similar techniques can be utilized for embodiments, aggregating audience data for an instance of a program across one or more media outlets. In some cases, applying the techniques described herein can deliver a larger audience sample, so that filters can be used without reducing reliability of the data.

The term “program,” as used herein, generally refers to a series of content items grouped together by a schedule of airing times on one or more media outlets. In some cases, however, the term program can also refer to a single instance of content, and to groups of content items not necessarily arranged in a series.

The source of information to define a given program may include automated or manually entered data received from a content provider such as Media Monitors, data entered by end-users to define their own “custom” Program schedule, or some other suitable source.

Calculating Audience Reaction to a Program

According to at least one embodiment, the techniques described herein can be used to determine audience reaction to a program. For example, given the following inputs:

| | |
|---|---|
| Required in some | |
| embodiments: | |
| Program Id | Identifies which Program is to be reported |
| Day to Examine | The Date for which the Audience Reaction is to be |
| | evaluated |
| Start Date | Starting Date to use for determining Audience Reaction |
| | Averages |
| End Date | Ending Date to use for determining Audience Reaction |
| | Averages |
| Optional in some | |
| embodiments: | |
| Content Provider | Content Provider filter (e.g. Market, Broadcast TV, |
| | Cable TV, Network) |
| Days | Day of the week filter |
| In\Out of Home | In Home, Out of Home, All Panelists filter |
| Age Group | Age Group filter |
| Gender | Gender Filter |
| Race | (Not currently used) |
| Language | (Not currently used) |

The process will generate the following outputs:

| | |
|---|---|
| dailycount_average | The Average number of Consumers (e.g., Listeners, Watchers) per |
| | minute of the Program on the Day to Examine |
| dailycount_average_IH | The Average number of In-Home Consumers per minute of the |
| | Program on the Day to Examine |
| dailycount_average_OH | The Average number of Out-of-Home Consumers per minute of the |
| | Program on the Day to Examine |
| avgcount_average | The Average number of Consumers (e.g., Listeners, Watchers) per |
| | minute of the Program over the course of the Start Date through |
| | End Date range |
| avgcount_average _IH | The Average number of In-Home Consumers per minute of the |
| | Program over the course of the Start Date through End Date range |
| avgcount_average_OH | The Average number of Out-of_Home per minute of the Program |
| | over the course of the Start Date through End Date range |

For each Minute of the airing of the Program:

| | |
|---|---|
| Minute_Id | Minute offset into the Start of the program (in other words a |
| | value of 27 means the 27^{th} minute of the airing of the |
| | program) |
| Avg_Count | The Average number of Consumers (e.g., Listeners, |
| | Watchers) of the Program during Minute_Id over the course |
| | of the Start Date through End Date range |
| Avg_Count_IH | The Average number of In-Home Consumers of the Program |
| | during Minute_Id over the course of the Start Date through |
| | End Date range |
| Avg_Count_OH | The Average number of Out-of-Home Consumers of the |
| | Program during Minute_Id over the course of the Start Date |
| | through End Date range |
| Event_Count | Actual number of Consumers of the Program at Minute_Id |
| | on the Day to Examine |
| Event_Count_IH | Actual number of In-Home Consumers of the Program at |
| | Minute_Id on the Day to Examine |
| Event_Count_OH | Actual number of Out-of_Home Consumers of the Program |
| | at Minute_Id on the Day to Examine |
| Diff_EventCount_AvgCount | The difference between Event_Count and Avg_Count |
| Diff_EventCount_AvgCount_IH | Event_Count_IH less Avg_Count_IH |
| Diff_EventCount_AvgCount_OH | Event_Count_OH less Avg_Count_OH |
| Tuned_In | The number of Consumers who Tuned In to a Station airing |
| | the Program at Minute_Id over the course of the Start Date |
| | through End Date range |
| Tuned_In_IH | The number of In-Home Consumers who Tuned In to a |
| | Station airing the Program at Minute_Id over the course of |
| | the Start Date through End Date range |
| Tuned_In_OH | The number of Out-of-Home Consumers who Tuned In to a |
| | Station airing the Program at Minute_Id over the course of |
| | the Start Date through End Date range |
| Tuned_Out | The number of Consumers who Tuned Away from a Station |
| | airing the Program at Minute_Id over the course of the Start |
| | Date through End Date range |
| Tuned_Out_IH | The number of In-Home Consumers who Tuned Away from |
| | a Station airing the Program at Minute_Id over the course of |
| | the Start Date through End Date range |
| Tuned_Out_OH | The number of Out-of-Home Consumers who Tuned Away |
| | from a Station airing the Program at Minute_Id over the |
| | course of the Start Date through End Date range |

For each minute, some embodiments may also calculate switching as described in the Media Analysis provisional.

In at least one embodiment, Average is calculated based on Start/End Date. In other embodiments, the Average can be calculated based on additional or different criteria to allow a user to choose another episode of the program or a similar program to compare against.

Additionally, the output of the process can include a list of the stations on which the program airs. These results can be used to generate various graphs and plots that may aid in the evaluation of audience responses to a program. The values can be computed as follows:

Using the Program_Id, retrieve the program schedule. The program schedule generally includes the stations on which the Program airs. For each station, the program schedule generally includes the days of the week and the start and end times of each airing.

Retrieve the PPM Event records which match the following criterion:
a. Station is one of the stations on which the program airs;
b. Event Date is within the requested Start and End Date range and\or is equal to the requested Day to Examine (which may or may not be within the Start through End Date range);
c. The Event Date is on a day of the week on which the Program airs on the Station;
d. The Event Date is on a day of the week which matches the Days filter parameter, if any;
e. The Event Time is within the Start and End time of the program on each Station;
f. The Consumer's (Panelist) Demographics match the requested demographic parameters, if any (e.g., Age, Gender); and
g. The Event In-Home\Out-of-Home indicator matches the In\Out of Home filter parameter, if any.

Each Event record thus retrieved can represent exactly one consumer and exactly one minute of consumption on one of the stations during the airing of the program. Each Event record can also contain an indication of whether the Consumer was In-Home or Out-of-Home at the time of consumption.

In various embodiments, the exact minute within the airing of the program is identified by the Minute_Id data element. For example, if a 3 hour Program begins to air at 10:00 AM on Station 1 and the Event time is 12:17 PM, then the Minute_Id can have a value of 137. If, on Station 2, the Program begins to air at 9:00 AM and the Event time is 11:17 AM, the Minute_Id for that Event record will also be 137. In this way, the Minute_Id represents the offset in Minutes from the beginning of the Program on each Station.

Tune Ins and Tune Outs can be determined on a minute-by-minute basis. A Tune In occurs when a given Consumer has an Event record for a given station in one minute for which they did not have an event record in the previous minute. A Tune Out occurs when a given Consumer has an event record for a given station in one minute for which they do not have an event record in the next minute.

It is possible for a given Consumer to have event records for more than one station for the same minute (date and time). These are “overlapping” event records. In some embodiments, before the number of Tune Ins and Tune Outs is computed, the overlapping event records are eliminated to avoid incorrect counts. Overlapping event records can be handled in the following manner:
a. For each Minute where a Panelist is credited with more than one Station, if at least one of them is a Station on which the Program airs, eliminate from consideration those Event record(s) of that Minute where Station_id is not a station on which the Program airs
b. This is an overlapping record which indicates that the consumer did not Tune In to or Tune Out of the station airing the program at that minute. Instead, in some embodiments, the consumer can be credited for being tuned in to that station and some other Station(s) during that same minute. In some such cases, the consumer will be counted for the station airing the Program and ignored for the other Stations.
c. For each Minute where a Panelist is credited with more than one Station, if none of the Stations is one on which the Program airs eliminate all but one of the Event record(s) of that Minute.

This process can be performed for each minute of the Airing of the program on the Day to Examine (Event Date=Day to Examine parameter). Once the overlapping Event records are eliminated, a proper counting of Tune Ins and Tune Outs per minute can be done.

Having gathered all of the above data, the following results can be computed:

The following can be computed for the overall duration of the program:

| Data Element | Computed as |
|---|---|
| dailycount_average | Count of the number of Event records where the Event Date equals |
| | the Day to Examine divided by the number of minutes in the |
| | Program |
| dailycount_average_IH | Count of the number of Event records where the Event Date equals |
| | the Day to Examine and the In-Home indicator equals 1 divided by |
| | the number of minutes in the Program |
| dailycount_average_OH | Count of the number of Event records where the Event Date equals |
| | the Day to Examine and the Out-of-Home indicator equals 1 |
| | divided by the number of minutes in the Program |
| avgcount_average | Count of the number of Event records divided by the number of |
| | minutes in the Program |
| avgcount_average _IH | Count of the number of Event records where In-Home indicator |
| | equals 1 divided by the number of minutes in the Program |
| avgcount_average_OH | Count of the number of Event records where the Out-of-Home |
| | indicator equals 1 divided by the number of minutes in the Program |

The following can be computed for each minute of the airing of the Program:

| | |
|---|---|
| Minute_Id | A value from 0 through the duration of the Program |
| | in Minutes (A three hour program will return data |
| | for Minute_Id 0 through 180. A value of 27 means |
| | the 27^{th} minute of the airing of the program) |
| Avg_Count | The Average number of Consumers (e.g., Listeners, |
| | Watchers) of the Program during Minute_Id over |
| | the course of the Start Date through End Date range |
| Avg_Count_IH | The Average number of In-Home Consumers of the |
| | Program during Minute_Id over the course of the |
| | Start Date through End Date range |
| Avg_Count_OH | The Average number of Out-of-Home Consumers |
| | of the Program during Minute_Id over the course of |
| | the Start Date through End Date range |
| Event_Count | Actual number of Consumers of the Program at |
| | Minute_Id on the Day to Examine |
| Event_Count_IH | Actual number of In-Home Consumers of the |
| | Program at Minute_Id on the Day to Examine |
| Event_Count_OH | Actual number of Out-of Home Consumers of the |
| | Program at Minute_Id on the Day to Examine |
| Diff_EventCount_AvgCount | Event_Count-Avg_Count |
| Diff_EventCount_AvgCount_IH | Event_Count_IH-Avg_Count_IH |
| Diff_EventCount_AvgCount_OH | Event_Count_OH-Avg_Count_OH |
| Tuned_In | Count one Tune In for each instance where a given |
| | Consumer has an Event record for a Station on |
| | which the Program airs in Minute_Id for which they |
| | do not have an Event record for that Station in |
| | Minute_Id-1. |
| Tuned_In_IH | If the above Event record has an In-Home indicator |
| | value of 1, then count it as an In-Home Tune In |
| Tuned_In_OH | If the above Event record has an In-Home indicator |
| | value of 6, then count it as an Out-Of-Home Tune In |
| Tuned_Out | Count one Tune Out for each instance where a given |
| | Consumer has an Event record for a Station on |
| | which the Program airs in Minute_Id-1 for which |
| | they do not have an Event record for that Station in |
| | Minute Id |
| Tuned_Out_IH | If the above Event record has an In-Home indicator |
| | value of 1, then count it as an In-Home Tune Out |
| Tuned_Out_OH | If the above Event record has an In-Home indicator |
| | value of 6, then count it as an Out-Of-Home Tune |
| | Out |

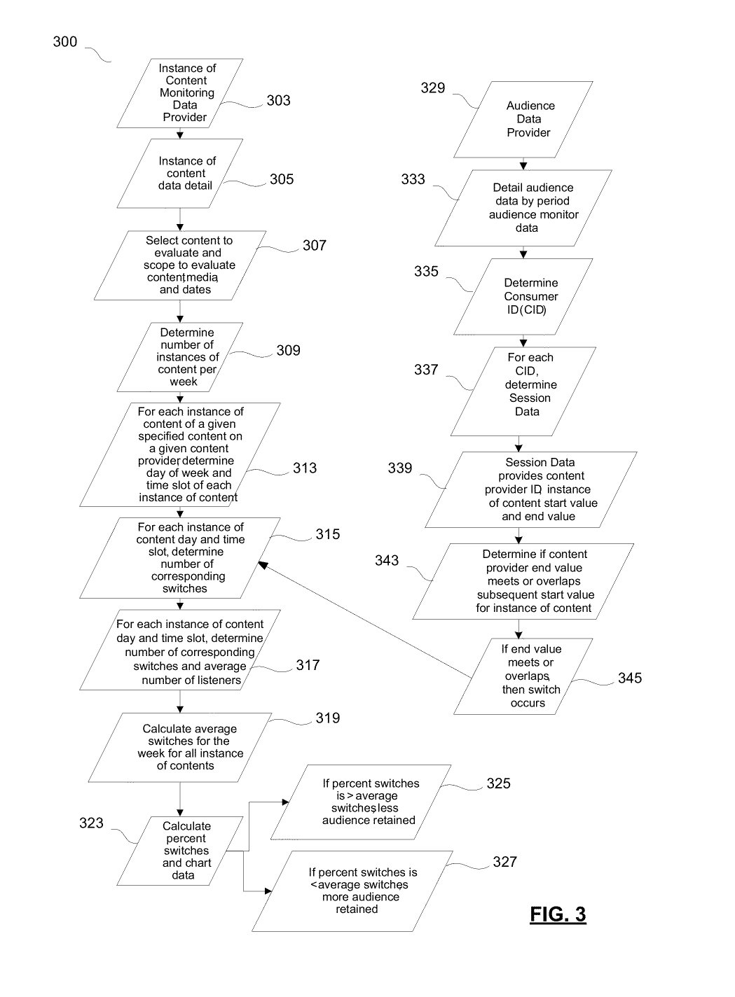

Referring now to FIG. 4, a flowchart illustrating an embodiment of a method 400 for analyzing program audience reaction. As illustrated by block 410, information can be received from a content monitoring data provider. As illustrated by block 412, detailed data regarding instances of programs can be input or received. In some embodiments, the information received from a content monitoring data provider may include automatically determined program airplay dates and times calculated from schedule information or live, playing information.

As illustrated by block 414, the program to be evaluated can be selected, and the scope of the evaluation chosen. For example, the date to be evaluated, which average criteria to consider, and any data filters are to be applied can be selected. As illustrated by block 416, the media outlets that aired the program are determined. As illustrated by block 418, levels and switching from all media outlets airing the program can be aggregated based on data received from an audience data provider.

As illustrated by block 422, if filters were chosen, they can be applied to the aggregated data. The average audience can be determined based on the desired and chosen average criteria, as illustrated by block 424. As illustrated by block 426, the average audience and program audience can be graphed for visual comparison.

As illustrated by block 430 audience data can be received from an audience data provider. As illustrated by block 432, the received data can be detailed audience data by period. As illustrated by block 434, a consumer identifier (CID) associated with particular audience data can be identified. And as illustrated by block 436, for each CID, session data can be determined. As illustrated by block 438, session data can include a CID, Media Outlet (content provider ID), Date, Start/End Time for a single listening/viewing instance, which falls within a given monitoring period. As illustrated by block 418, the session data can be used to determine the aggregation of levels and switching from multiple media outlets.

As illustrated by block 440, switching events can be analyzed to determine if content provider end values met or overlapped subsequent start value for the instance of content. As illustrated by block 442, if the end value meets or overlaps, then a switch is determined to have occurred.

In some embodiments, the Audience Reaction can be calculated and graphed without regard to the Program. In some such embodiments, the Audience Reaction for a given Content Provider (or filtered list of providers) throughout each minute of the day, regardless of the content being aired, is calculated and graphed.

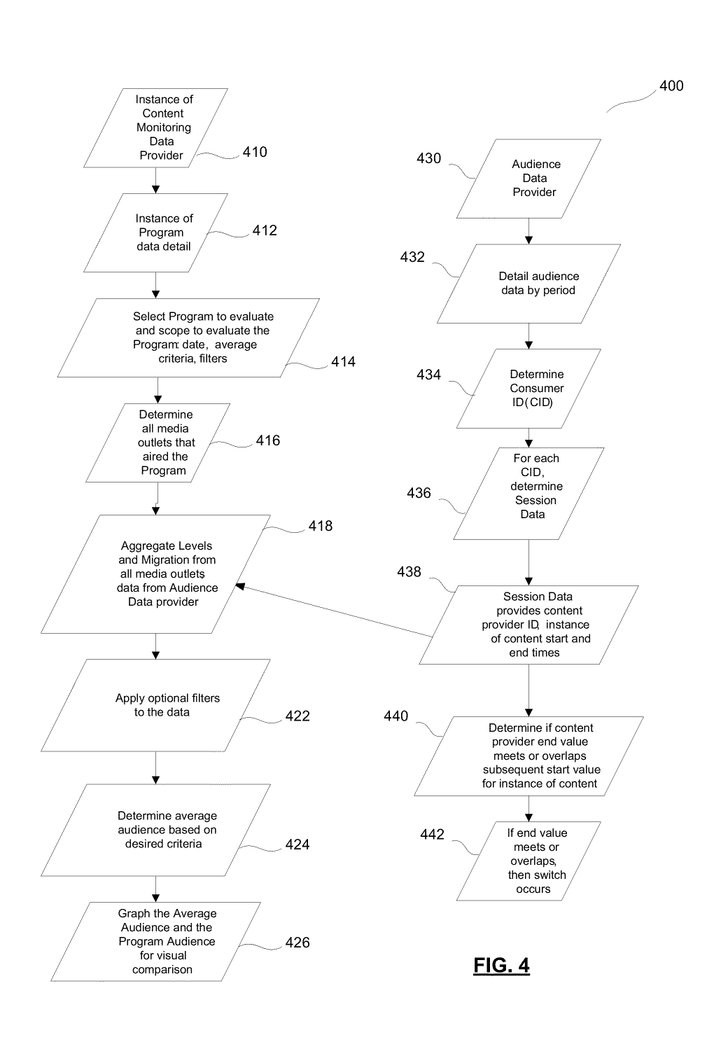

Some or all of the methods and processes described herein can be embodied in or performed by one or more processing systems. An example of such a processing system is discussed with reference to FIG. 5. Processing system 500 includes random access memory (RAM) 520; read-only memory (ROM) 515, wherein the ROM 515 could also be erasable programmable read-only memory (EPROM) or electrically erasable programmable read-only memory (EEPROM); and input/output (I/O) adapter 525, for connecting peripheral devices such as disk units 530, optical drive 536, or tape drive 537 to system bus 510; a user interface adapter 540 for connecting keyboard 545, mouse 550, speaker 555, microphone 560, or other user interface devices to system bus 510; communications adapter 565 for connecting processing system 500 to a network 567 such as the Internet or any of various local area networks, wide area networks, telephone networks, or the like; and display adapter 570 for connecting system bus 510 to a display device such as monitor 575. Mouse 550 has a series of buttons 580, 585 and may be used to control a cursor shown on monitor 575.

It will be understood that processing system 500 may include other suitable data processing systems without departing from the scope of the present disclosure. For example, processing system 500 may include bulk storage and cache memories, which provide temporary storage of at least some program code in order to reduce the number of times code must be retrieved from bulk storage during execution.

A further aspect of audience response being based on user trends over a span of content during a media content session is provided.

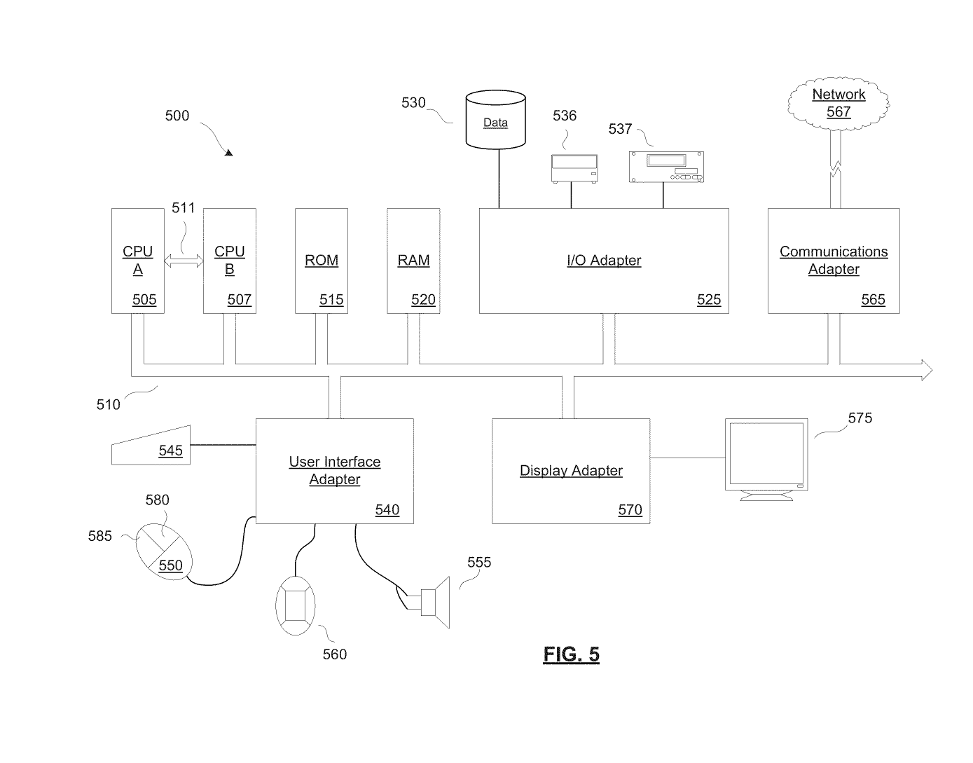

FIG. 6 illustrates system 600 that may include the processing system 500 of FIG. 5, and digital-media content playback devices 602 and 604 communicatively coupled by network 567. The network 567 may take the form of the Internet, and the plurality of digital-media content playback devices 602 and 604 may further couple with the processing system 500 via use of Wireless Application Protocol (WAP), Short Message Service (SMS), Multimedia Messaging Service (MMS), or WiFi protocols, for example.

The processing system 500, in this example, serves as a digital-media content services that provides a digital media content stream, which may be delivered over the network 567. The digital media content stream in this example may be provided over the communication links 603, 607, 609 and/or 608 over the network 567.

The digital media content stream includes a plurality of digital-media content that may include an airplay parameter. The airplay parameter may be based upon the program schedule, which generally includes the stations, or channels, on which one or more of the programs air. For each station, or channel, the program schedule generally includes the days of the week and the start and end times of each airing. “Program” generally refers to a series of digital media content items grouped together by a schedule of airing times via digital media content service. In some cases, however, the term “program” may refer to a single instance of digital media content, and to groups of content items not necessarily arranged in a series.

Referring again to FIG. 6, the processing system 500 provides general function blocks that may include a file server 614, a data store in the form of a file database 616 to contain digital-media content, a content delivery/management module 612, and/or a transcoding service module 610.

The content delivery/management module 612 may index files of reduced media content (e.g., ringtones), full-track media content, games, wallpaper, and graphics from the file server 614 into the file database 616 and in a structured manner, as provided for delivery via the digital media content stream to the plurality of digital media content playback devices 602 and 604.

The transcoding service module 610 prepares communications suitable for transmission over the network 567 by converting the encoding of the communications from one format to a different format.

Referring to FIG. 6, the digital media content playback devices 602 and 604 may be provided as a desktop computer, or an enterprise storage devices such a server, of a host computer that is attached to a storage array such as a redundant array of independent disks (RAID) array, storage router, edge router, storage switch and/or storage director.

A user may view still digital images or video (e.g., a sequence of digital images) content via the devices. Also, certain embodiments of the digital-media content playback devices may include one or more audio output devices (e.g., by wirelessly or hardwired speakers that are not shown in FIG. 6) to allow the outputting of audio digital-media content.

The plurality of digital-media content playback devices 602 and 604 may be standalone high definition (HD) monitors, which may couple to the digital media content stream provided by the processing system 500 directly, via a content adapter 606 (e.g., set top box, digital video disc (DVD) player, digital-to-analog converter, computer), and/or indirectly, such as via wireless link 608. For further example, an HD monitor may include an integrated tuner to allow the receipt, processing, and decoding of media content (e.g., television broadcast signals, cable digital streaming content) thereon.

For example, sometimes an HD monitor receives a digital media content stream from another source such as a digital video disc (DVD) player, set top box (STB) that receives, processes, and decodes a digital media content stream delivered by a cable and/or a satellite television broadcast signal (or alternatively, an over the air broadcast signal). Regardless of the particular implementation, the digital media content playback device may be implemented to perform media processing as described herein.

In a further aspect, one or more of the plurality of the digital-media content playback devices 602 and 604 may be provided as a handheld media unit, which may operate to provide general storage or storage of image/video content information such as joint photographic experts group (JPEG) files, tagged image file format (TIFF), bitmap, motion picture experts group (MPEG) files, Windows Media Architecture (WMA) files, other types of video content such as MPEG4 files, MPEG10 files, et cetera, for playback to a user, and/or any other type of information that may be stored in a digital format.

Historically, such handheld media units had been primarily employed for limited storage and playback of audio media; however, such a handheld media unit may be employed for storage and playback of virtual any digital content of a media digital media content stream (e.g., audio media, video media, photographic media, et cetera). Moreover, such a handheld media unit may also include other functionality such as integrated communication circuitry for wired and wireless communications. Such a handheld media unit may be implemented to perform media processing as described herein.

Also, the content adapter 606 of FIG. 6, illustrates an embodiment of a set top box (STB). As mentioned above, sometimes a STB 606 may be implemented to receive, process, and decode a digital media content stream delivered via a cable and/or satellite television broadcast signal to be provided to any appropriate display capable device such as the digital-media content playback devices 602 and 604. Such an STB 606 may operate independently or cooperatively with such a display capable device to perform media processing as described herein.

It is noted that any of a wide variety of digital-media content playback capable devices may incorporate various embodiments presented herein. While many such devices are described above with respect to the FIGS. 5 and 6, these diagrams do not constitute an exhaustive list of such media capable devices, and any media capable device (e.g., including portable devices, multi-functional devices [such as a combined phone/media capable device], a media capable device implemented within a vehicle, et cetera) may be implemented in accordance with the various aspects presented herein.

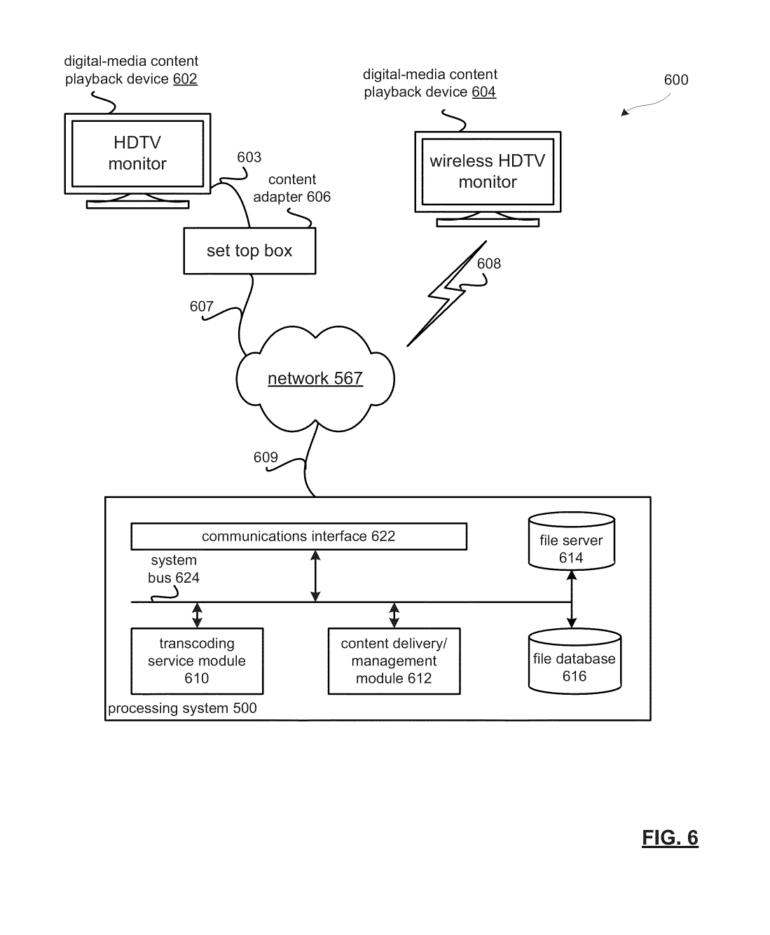

FIG. 7 illustrates an example of data collection of playback of digital media content via a digital media content playback device 602 and 604, or via the content adapter 606 of FIG. 6. The playback of the digital media content of a digital media content stream 702 is a simplified representation for illustrating data collection based upon user viewing and/or listening behaviors, as identified based upon audience data for that user.

The audience data serves to identify audience member characteristics that playback the plurality of the digital media content 704, 714, 724 . . . xxx. For example, audience member characteristics may include, without limitation, whether user is In\Out of Home, the user's Age Group, Gender, Race, et cetera.

Each of the digital media content 704, 714, 724 and xxx of the program 700 provided via the digital media content stream 702 may have characteristics specific to that content. For example, the digital media content 704 generally has an airplay parameter characteristic.

In some embodiments involving a digital-media content stream 702 including radio or streaming audio, the characteristics for each airplay of the content, and the corresponding day and song playback duration 707 for the airplay of the content within the data range is used to calculate the average number of station switches.

Such determinations may be also provided for other media content including video, text, written content, television, Internet, et cetera. Also, digital-media content services may include media content providers such as television stations and websites.

With a digital content stream being played back, information regarding the habits or trends may be shown regarding characteristics of the audience. For example, the processing system 500 operates to receive, at predetermined time intervals, digital-media content information indicating playback duration 707 of each of a plurality of digital-media content 704, 714, 724 . . . xxx. The digital-media content includes detailed data regarding instances of programs or content. In some embodiments, the digital-media content information may include automatically determined program airplay dates and times calculated from schedule information or live, playing information, indicating the airplay parameter 710 for each of the digital-media content 704, 714, 724 . . . xxx.

In general, the churn rate may be based upon the audience members that switch out during a playback of a digital-media content versus the total number of listeners and duration 707, and further by the percentage of the digital media content as considered by the playback duration 707 over the airplay parameter 710.

With the audience data indicating the number of the listening/viewing audience, the magnitude of the switch, or churn, rate may be determined based upon a number of digital media content switches 708 for each of the plurality of digital media content 704, 714, 724 . . . xxx, by at least one audience member of the audience members. In this manner, audience response to a program, or to digital-media content, playback may be conducted by evaluating audience switching by, for example, time, content-provider, channel, geographic and economic market, content type (such as audio, genre, et cetera), socio-demographics and in general any grouping or subdivision of those, as well as any other kind of audience measurement (such as web site impressions, for example).

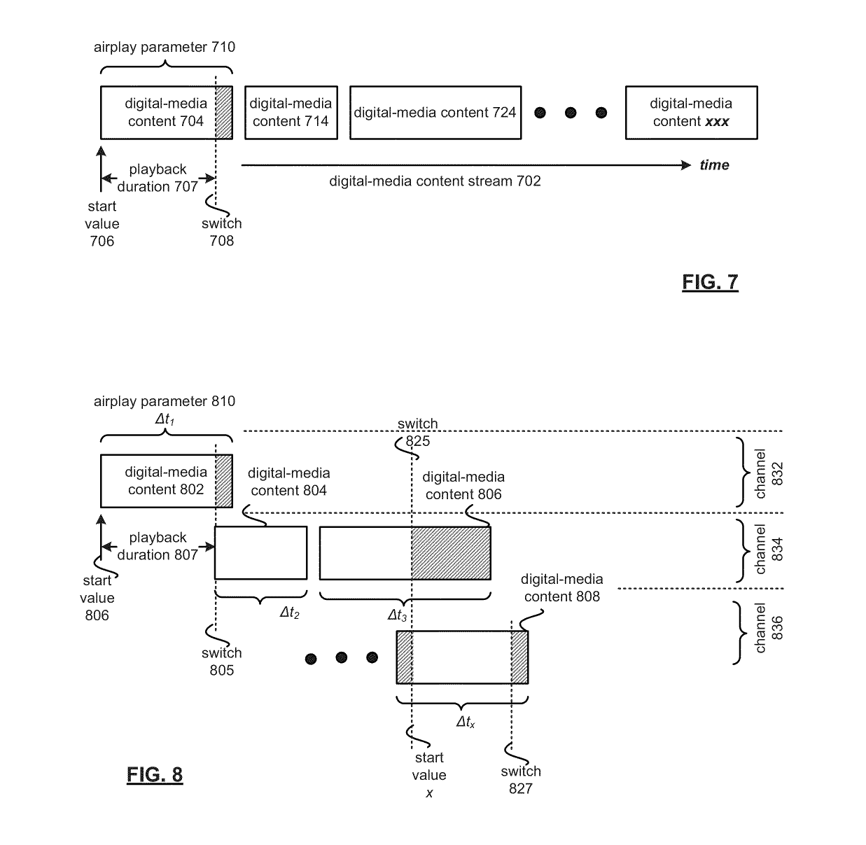

FIG. 8 further illustrates another embodiment when the switch involves a tune-out or transition to other channels, including channel 832, 834, and 836 in this example. The overlap indicates the playback observed by the user, as upon a switch, another digital media content may be queued for playback to a digital-content playback device. Digital media content 802 may include an airplay parameter 810 of Δt₁, digital-media content 804 of Δt₂, and/or digital-media content 806 of Δt₃. As shown, a switch 805 may occur to digital-media content 802, producing a playback duration 807 measured from the start value 806. Upon the switch 805, digital media content 804 may be queued for playback, which has a airplay parameter 810 of Δt₂. As shown in the example, a switch may not occur for this digital-media content 804, and playback continues to the digital media content 806, in which the user may switch at switch 825 to another digital-media content 808 at channel 836.

As shown, the playback of digital media content 808 might not begin at the initial start of the content, but instead starts past the initial start at the start value x, which can be determined in the digital data related to the content. As shown, the user may switch at switch 827 the digital-media content 808 to yet another digital media content. In this manner, the user behavior regarding the digital-content media is discerned, and provided to processing system 500 (see FIGS. 5 and 6).

Referring briefly back to FIGS. 1 and 2, the time periods run along the X axis of the graphs. The numbers along the Y2 axis on the right side of the graphs represent a percent value of audience members tuning away, or switching to a different station, with zero-percent (0%) representing an expected, or normalized, percentage of switches.

With regard to instances where a switch does not occur, for example with regard to digital-media content 804 (or that of digital-media content 714), the viewing of that single portion might not convey the effect of that content to a program, for example, of the audience reaction to the program or digital media content stream generally. In this regard, the effect of a digital media content-of-interest is desired to indicate user retention in general. That is, lower granularity may be produced by a factored churn rate, and may produce a corresponding retention rate for the digital-media content.

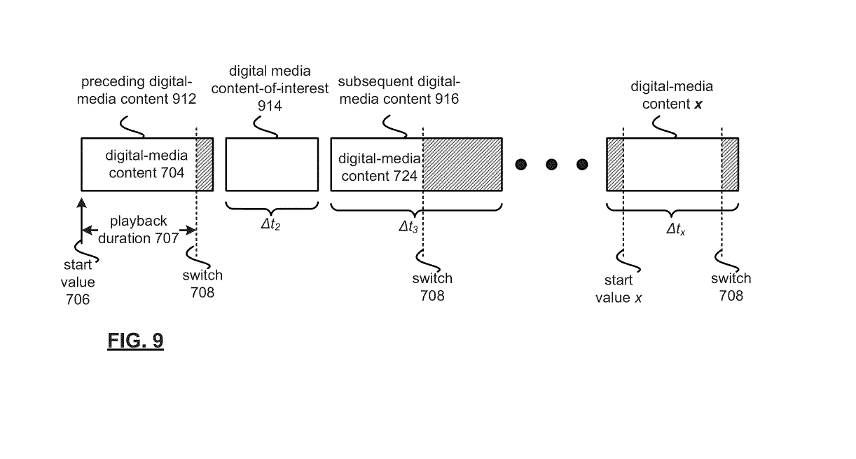

FIG. 9 illustrates determining a retention rate based on factored churn rate for a digital media content-of-interest 914. In this regard, the digital media content-of-interest may be identified by a variety of characteristics, as well as the user characteristics. For example, the content-of-interest may be set out by Program ID, a Day to Examine, a Start Date, and/or End Date, for example.

The churn rate, or number of average switches, may be based upon the audience response to adjacent, or sufficiently adjacent, digital-media content, such as that of digital media content 704 and digital-media content 724. As noted, the churn rate of the digital media content-of-interest 914 with respect to the individual audience member is non-existent in this example. However, with regard to audience member behavior, further information may be gathered with respect to the behavior to adjacent digital media content.

On a per-digital media content basis, the factored churn rate may be based on the song rate less the average churn rate across audience members, factored by a churn rate standard deviation based on the churn rate of the adjacent digital-media content.

In the example shown by FIG. 9, the churn rate standard deviation is based upon a churn rate of the digital-media content of preceding digital media content 912 and that of the digital-media content 916 for the audience member. Further, the churn rate standard deviation may be further refined by taking into consideration the churn rates for the preceding and subsequent digital media content 912 and 916, respectively.

By factoring the churn rate for the digital media content-of-interest 914 with regard to the adjacent digital media content, a factored churn rate may be produced for the digital media content-of-interest to indicate a general audience members' retention rate for the audience member relative to the digital media content-of-interest. Also, with a cumulative retention rate, an average retention may be generated over multiple instances of playback of the digital-media content-of-interest.

A digital-media content retention rate, in this manner, is based upon audience member switching, and playback duration 707 prior to a switch 708. Further, the retention rate of a single audience member may be compared to other audience members' retention in order to produce a cumulative retention rate, which may then be normalized based on a natural listening curve.

A natural listening, or consumption, curve for media reflects the audience consumption pattern for media generally. The audience consumption may be based upon audio, video, or a combination thereof. The consumption pattern may be further refined to specific market categories (geographic region, urban, content-category, and the like). As an example, media-content consumption, such as listening through wireless reception (FM, AM, HD, streaming, etc), ebbs and flows over the course of the work day, and may be a further different consumption pattern over the weekend. That is, on a national level for example, the rush hour period (around 7:00 am) leads consumption during the Monday through Friday work week, followed by 3 p.m and the noon hour. Peaks typically highlight these time periods. In contrast, the natural listening curve for weekend listening may provide a more rounded curve, indicating that consumption may build gradually to a mid-day peak and may gradually drop off at a similar rate. Also, curves may be indicative for each unique. These curves may show localized influences and may reflect how and when listeners may participate in consuming content programming. Normalizing the retention rate with regard to a natural listening curve may place the retention rate in context with the audience consumption patterns.

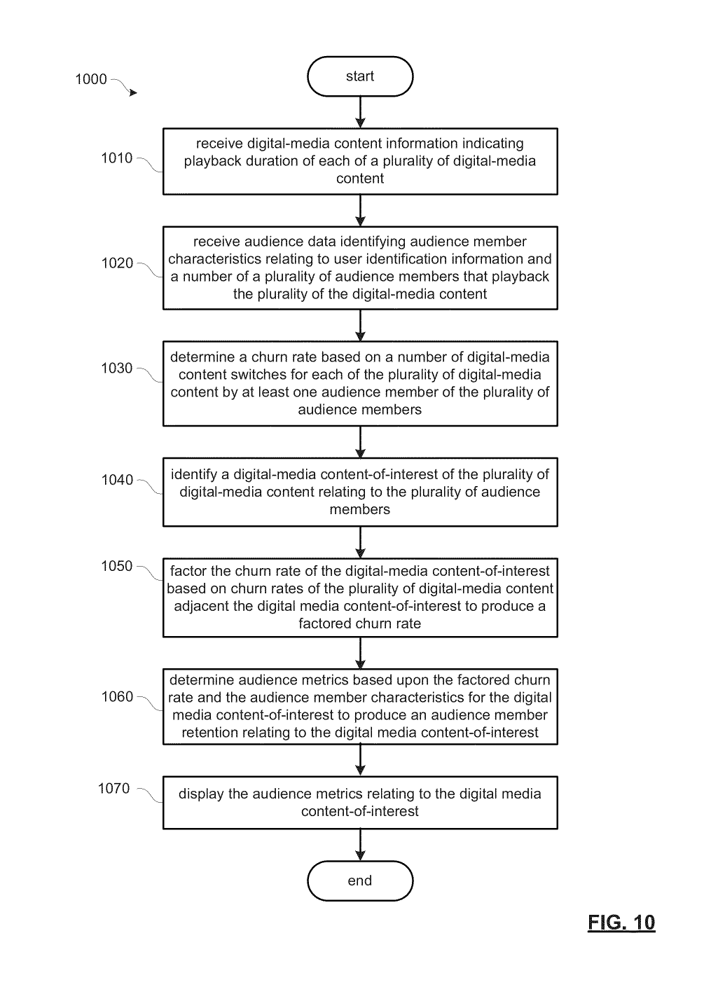

FIG. 10 illustrates a method 1000 determining audience member metrics relating to a digital-media content-of interest. At step 1010, a processing system, such as that of FIGS. 5 and/or 6, may receive digital-media content information indicating playback duration of each of a plurality of digital-media content. The plurality of digital-media content may be provided by at least one digital media content service via a digital-media content stream to an audience member.

The digital-media content service may be provided via a network or in situ on a buffered or queued basis locally with a device in local memory. That is, the digital-media content stream may be delivered in a real-time (or near real-time) stream by the network, or be locally provided with regard to the device on local memory (such as USB 1.0, USB 2.0 Flash Drive, IEEE 1394, RAM, system RAM 520, disk units 530, etc.), or a combination thereof. Also, the network may include a landline network under IEEE 802.3 specifications or telephony network (such as PSTN, DSL, DOCSIS, etc.), under wireless local area network per IEEE 802.11 specifications, under a cellular network (such as 3G, 4G, LTE, etc.), under a Bluetooth and/or personal area network, or a combination thereof to facilitate delivery of the content stream. The content service may provide multiple channels, along with multiple content characteristics relating to demographics, play time, genre, et cetera.

The processing system operates to determine an audience member, or members, reaction to digital-media content. The digital-media content information may be provided at predetermined time intervals, that may be prearranged, or a function of providing the content to an audience member.

At step 1020, the processing system receives audience data that identifies audience member characteristics. For example, audience member characteristics may include, without limitation, whether user is In/Out of Home, the user's Age Group, Gender, Race, et cetera. Also, the information includes user identification information such as age group, and an identifier of the audience member relating to playback of the digital media content

At step 1030, the processing system determines a churn rate based on a number of digital media content switches for each of the plurality of digital media content by at least one audience member of the plurality of audience members. A media content switch may include switching away from a digital media content stream to another digital media content stream of the at least one media service provider prior to completing the playback of the digital media content. An example is changing from one station of a digital media content service to another, or change in one digital media content service to another. Also, a media content switch may also include advancing to another digital media content during the playback of a digital-media content.

The churn rate may be based upon audience members that switched during playback of a digital media content by the total number of listeners and airplay parameter for the digital media content, generating a churn rate per second metric.

A digital media content-of-interest is identified at step 1040. The identification may occur prior to receiving the digital-media content information, or subsequently to receipt of the plurality of digital media content information relating to the plurality of audience members. With the digital media content-of-interest identified, the method continues to factor the churn rate of the digital media content-of-interest to produce a retention rate for that content-of-interest. In the factoring process, churn rates of digital media content adjacent the digital media content-of-interest is solicited, and factored into the churn rate of the content-of-interest. The retention rate relays information relating to the desirability of the content-of-interest, and the likelihood or retaining an audience member for the airplay parameter of the content.

The retention rate for on a content-of-interest basis is produced by the factoring of the associated churn rate is based upon song rate less a churn rate average for the content-of-interest, factored by a churn rate standard deviation. The churn rate standard deviation is based upon churn metrics of digital media content adjacent to the digital-media content-of-interest. For example, the churn rate standard deviation may be provided by a centered, sliding sample of N+1 media content. That is, N/2 preceding media contents, the digital media content-of-interest, and N/2 subsequent digital media contents.

At step 1060, the processing system determines audience metrics based upon the factored churn rate and the audience member characteristics for the digital media content-of-interest to produce an audience member retention relating to the digital media content-of-interest. At step 1070, the metrics are displayed via a monitor, such as a monitor 575 (see FIG. 5).

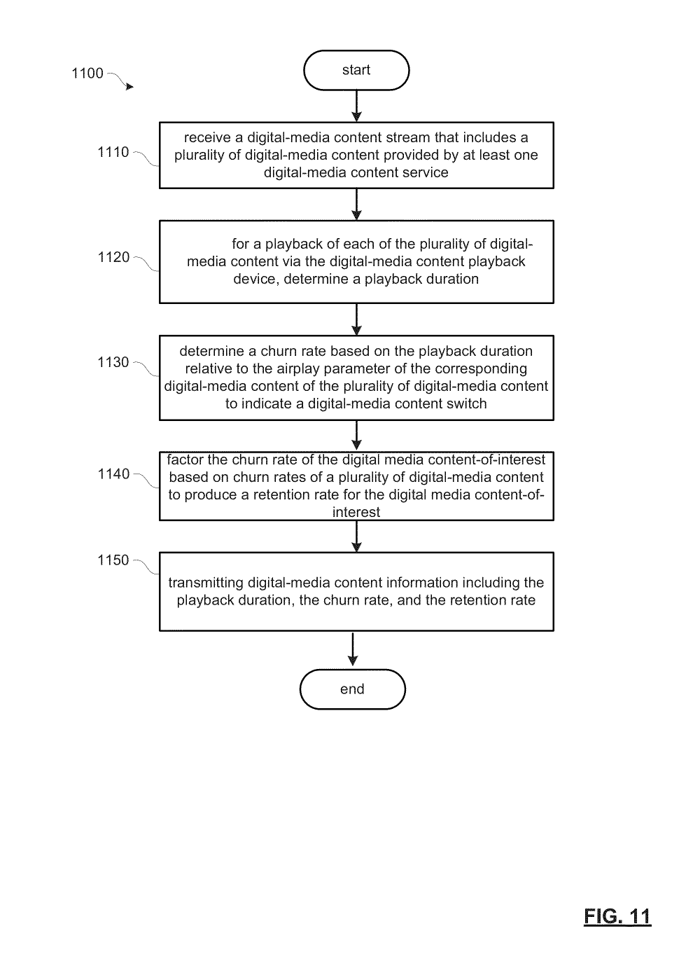

FIG. 11 illustrates a method 1100 determining audience member metrics relating to a digital-media content-of interest. At step 1110, a digital media content playback device, such as that of FIGS. 5 and/or 6, receives a digital media content stream that includes digital-media content. The plurality of digital-media content is provided by at least one digital media content service via a digital-media content stream to the audience member of the playback device. The content service may provide multiple channels, along with multiple content characteristics relating to demographics, play time, genre, et cetera.

At step 1120, for a playback of each of the plurality of digital media content, the determining a playback duration, and determining, at step 1130, a churn rate based on the playback duration with respect to the airplay parameter of the corresponding digital media content of the plurality of digital media content to indicate a digital media content switch.

In general, the churn rate may be based upon the audience members that switch out during a playback of a digital-media content versus the total number of listeners and playback duration, and further by the percentage of the digital media content, which may be produced the playback duration with respect to an airplay parameter for the digital-media content.

At step 1140, the digital media content playback device may produce an audience metric based upon a factored churn rate, and further upon audience characteristics. Upon generating a churn rate for digital media content in general, the churn rate for a digital media content-of-interest may be determined with regard adjacent media contents. That is, by including churn rate, or consumption habits of an audience member over a number of media playbacks, the churn may be attributable to the habit of the audience member to switch content frequently, or that a duration indicating holding the audience member's attention for a digital media content-of-interest may be indicative of the merits or attention-holding trend of the media content-of-interest; that is, determining a retention value for an audience member. The number of adjacent digital-media content relative to the content-of-interest may include the digital-media content preceding the content-of-interest, following the content-of-interest, and/or both. Moreover, additional digital-media content may be used to further expand the sampling of the churn rate generally.

The churn rate standard deviation may be based upon churn metrics of digital-media content adjacent to the digital-media content-of-interest. For example, the churn rate standard deviation may be provided by a centered, sliding sample of N+1 media content. That is, N/2 preceding media contents, the digital media content-of-interest, and N/2 subsequent digital-media contents.

At step 1150, the digital-media content playback device may transmit the digital-media content information including the playback duration, the churn rate, and the retention rate. The identification of the digital media content-of-interest may be provided with the digital-media content stream. In the evaluation, the improved audience demographics and consumption habits may facilitate advertising rates for content providers and media stations/services in industries such as terrestrial and satellite radio, cable, Internet, cellular telephone and other wireless communications, newspapers, billboards, and the like.

In this manner, a portion of the processing overhead for the metrics is apportioned among the devices involved in the playback of the digital-media content. That is, metrics specified to the audience member engaged in the playback can be included with the metrics data to a processing system 500, such as that of FIGS. 5 and/or 6. The division of the processing further expedites the retrieval of audience metrics, bringing the evaluation of the information to a near real-time evaluation.

The previous detailed description of embodiments of the disclosure depicted in the accompanying drawings. The embodiments are in such detail as to clearly communicate the disclosure. However, the amount of detail offered is not intended to limit variations of the described embodiments; on the contrary, the intention is to cover all modifications, equivalents, and alternatives falling within the spirit and scope of the present disclosure as defined by the appended claims.

What is claimed is:

1. A method comprising:
receiving, at predetermined time intervals, digital-media content information indicating playback duration of each of a plurality of digital-media content provided by at least one digital-media content service via a digital-media content stream, the digital-media content information includes user identification information associated with playback of at least one digital-media content and the at least one media content service;
receiving, at the predetermined time intervals, audience data identifying audience member characteristics relating to the user identification information and a number of a plurality of audience members that playback the plurality of the digital-media content;
determining a churn rate based on a number of digital-media content switches for each of the plurality of digital-media content by at least one audience member of the plurality of audience members;
identifying a digital media content-of-interest of the plurality of digital-media content relating to the plurality of audience members;
factoring the churn rate of the digital media content-of-interest based on churn rates of a plurality of digital-media content adjacent the digital media content-of-interest to produce a factored churn rate for the digital media content-of-interest;
determining audience metrics based upon the factored churn rate and the audience member characteristics for the digital media content-of-interest to produce an audience member retention relating to the digital media content-of-interest; and
providing the audience metrics relating to the digital media content-of-interest.

2. The method of claim 1, wherein at least one digital-media content switch of the number of the content-switches comprises at least one of:
switching away from a digital-media content stream to another digital-media content stream of the at least one media service provider prior to completing the playback of the digital-media content; and
advancing to another digital-media content during the playback.

3. The method of claim 1 further comprising:
determining a probability value relating to the plurality of audience members to engage in a digital-media content switch of the at least one media content service based on a digital media content service average for each minute of a day.

4. The method of claim 3, wherein the digital-media content service average further comprising:
determining an average number of the plurality of the audience members of the at least one media content service for the each minute of the day;
determining a digital-media content service average for a first group of times, wherein the digital-media content service average corresponds to an average playback over the at least one digital-media content service, and the first group of times includes each of a period of time during the playback of the digital media content-of-interest; and
determining a switch percentage value for the first group of times by including the number of the digital-media content switches less the digital-media content service average, per the average number of the plurality of the audience members.

5. The method of claim 4, further comprising:
determining a plurality of additional switch percentages for a plurality of second groups of times, wherein each of the plurality of second groups of times corresponds to an additional playback of the digital media content-of-interest; and
determining a periodic switch percentage based on an average of the plurality of additional switch percentages.

6. The method of claim 5, further comprising:
determining a plurality of periodic switch percentages; and
determining a rolling average of the plurality of periodic switch percentages over a designated time interval.

7. The method of claim 1, wherein the churn rates of the plurality of digital-media content include that of at least one preceding digital-media content churn rate and that of at least one subsequent digital-media content churn rate relative to the digital media content-of-interest.

8. The method of claim 1, wherein the churn rates of the plurality of digital-media content include that of at least one immediately preceding digital-media content churn rate and that of at least one immediately subsequent digital-media content churn rate relative to the digital media content-of-interest.

9. The method of claim 1, wherein the determining the churn rate further comprising:
determining a raw number of the plurality of audience members that selected the at least one digital-media content service to playback the plurality of the digital-media content;
determining a raw number of the plurality of the audience members that engaged in a digital-media content switch during the playback of the plurality of the digital-media content; and
determining a net-number of audience members that engaged in the digital-media content switch.

10. The method of claim 1, further comprising:
determining the number of the digital-media content switches for more than one digital-media content services;
determining an amount of audience members expected to engage in a digital-media content switch during the playback of the plurality of digital-media content delivered via the media content stream; and
assigning a performance factor to the digital media content-of-interest based on a correlation between a raw number of the plurality of the audience members that engaged the digital-media content switch during the playback of the plurality of digital-media content delivered against the amount of audience members expected to engage in the digital-media content switch.

11. The method of claim 1 wherein the digital-media content stream is delivered by at least one of:
a local area network;
a cellular network;
a wide area network;
a personal area network; and
local memory storage.

12. A method for execution in a digital-media content playback device, the method comprising:
receiving a digital-media content stream that includes a plurality of digital-media content provided by at least one digital-media content service, wherein each of the plurality of digital-media content includes an airplay parameter;
for a playback of each of the plurality of digital-media content via the digital-media content playback device, determining a playback duration;
determining a churn rate based on the playback duration relative to the airplay parameter of the corresponding digital-media content of the plurality of digital-media content to indicate a digital-media content switch;
factoring the churn rate of the digital media content-of-interest based on churn rates of a plurality of digital-media content to produce a retention rate relating the digital media content-of-interest; and
transmitting digital-media content information including the playback duration, the churn rate, and the retention rate.

13. The method of claim 12, wherein the churn rates of the plurality of digital-media content include that of at least one preceding digital-media content churn rate and that of at least one subsequent digital-media content churn rate relative to the digital media content-of-interest.

14. The method of claim 12, wherein the digital-media content switch comprises at least one of:
switching away from the digital-media content stream to another digital-media content stream prior to completing the playback of the digital-media content; and
advancing to another digital-media content during the playback; and
returning to another digital-media content during the playback.

15. The method of claim 12 further comprising:
determining a probability value relating to the audience member to engage in a digital-media content switch based on a digital-media content service average for each minute of a day.

16. The method of claim 15, wherein the digital media content service average further comprising:
determining the digital media content service average for a first group of times, wherein the digital media content service average corresponds to an average playback over the plurality of digital media content of at least one digital-media content service; and
determining a switch percentage value for the first group of times for the audience member by including a total number of the digital-media content switches less the digital-media content service average.

17. The method of claim 16, further comprising:
determining a plurality of additional switch percentages for a plurality of second groups of times, wherein each of the plurality of second groups of times corresponds to an additional playback of the plurality of the digital-media content; and
determining a periodic switch percentage based on an average of the plurality of additional switch percentages.

18. The method of claim 17, further comprising:
determining a plurality of periodic switch percentages; and
determining a rolling average of the plurality of periodic switch percentages over a designated time interval.

19. The method of claim 12, wherein the digital-media content stream is delivered by at least one of:
a local area network;
a cellular network;
a wide area network;
a personal area network; and
local memory storage.

20. A digital-media content playback device comprising:
a processor;
memory operably associated with the processor;
a communications interface coupled to the memory and the processor, the communications interface adapted to receive a digital-media content stream that includes a plurality of digital-media content provided by at least one digital-media content service, wherein each of the plurality of digital-media content includes an airplay parameter;
a program of instructions configured to be stored in the memory and executed by the processor, the program of instructions including:
for a playback of each of the plurality of digital-media content via the digital-media content playback device, determining a playback duration;
determining a churn rate based on the playback duration relative to the airplay parameter of the corresponding digital-media content of the plurality of digital-media content to indicate a digital-media content switch; and
factoring the churn rate of the digital media content-of-interest based on churn rates of a plurality of digital-media content to produce a retention rate for the digital media content-of-interest; and
transmitting digital-media content information including the playback duration, the churn rate, and the retention rate.

21. The digital-media content playback device of claim 20, wherein the churn rates of the plurality of digital-media content include that of at least one preceding digital-media content churn rate and that of at least one subsequent digital-media content churn rate relative to the digital media content-of-interest.

22. The digital-media content playback device of claim 20, wherein the churn rates of the plurality of digital-media content include that of at least one immediately preceding digital-media content churn rate and that of at least one immediately subsequent digital-media content churn rate relative to the digital media content-of-interest.

23. The digital-media content playback device of claim 1 wherein the digital-media content stream is delivered by at least one of:
a local area network;
a cellular network;
a wide area network;
a personal area network; and
local memory storage.
